(19) United States
(12) Patent Application Publication
(10) Pub. No.: US 2018/0150731 A1
(43) Pub. Date: May 31, 2018

(54) SYSTEMS AND METHODS FOR LABELING RELATED CONSUMER PRODUCTS WITH UNIQUE IDENTIFIERS

(71) Applicant: Wal-Mart Stores, Inc., Bentonville, AR (US)

(72) Inventors: Greg A. Bryan, Bentonville, AR (US); David C. Winkle, Bella Vista, AR (US); Cristy C. Brooks, Cassville, MO (US); Benjamin E. Enssle, Bella Vista, AR (US); Todd D. Mattingly, Bentonville, AR (US)

(21) Appl. No.: 15/820,849

(22) Filed: Nov. 22, 2017

Related U.S. Application Data
(60) Provisional application No. 62/428,306, filed on Nov. 30, 2016.

(51) Int. Cl. G06K 19/06

(52) U.S. Cl. CPC G06K 19/06028; G06Q 10/087; G06K 2019/06253

(57) ABSTRACT

In some embodiments, methods of labeling products are provided. An item representing one unit of a consumer product may be labeled with a unique label via automatically generating a random identifier unique to the item, associating the generated random identifier with the item in a record of an electronic database, creating a label comprising a substrate and the random identifier, and applying the label to the item. Products labeled with unique identifiers via such methods are also provided.

### CROSS-REFERENCE TO RELATED APPLICATION

This application claims the benefit of U.S. Provisional Application No. 62/428,306, filed Nov. 30, 2016, which is incorporated herein by reference in its entirety.

### TECHNICAL FIELD

This disclosure relate generally to consumer item labels and more particularly to devices, systems and methods for labeling related consumer products with unique identifiers.

### BACKGROUND

Retailer facilities such as large department stores and warehouses and distribution centers associated therewith receive, stock, and transport thousands, if not millions, of units of consumer products. An individual stock keeping unit or item of a consumer product typically includes a label attached thereto or printed thereon indicating the identifying code of the consumer product. For example, a bottle of a typical shampoo product displayed on a sales floor of a retail facility typically includes a label including a uniform product code (UPC) thereon that generally indicates a company code associated with the manufacturer of the shampoo bottle and a product code associated with the shampoo bottle.

Retail facilities typically rely on bar codes or other such machine readable codes to identify products and distinguish between products. Generally, these machine readable codes are difficult to see for workers, and workers typically use a code reading machine to scan and identify such products. For example, in requesting that a shopping facility worker locate a particular product (e.g., in a stock room for moving to the sales floor), the worker typically has to be provided with a portable code reader programmed with a unique code of a product that the worker is supposed to locate. The worker then has to look through the products stocked on shelves and read numerous different codes with the code reader in attempts to locate a particular product through trial and error. The locating of a desired product through machine readable code can be further complicated when, as is often the case, related products are stocked together on the same shelves, and the packaging of the related products is very similar to the packaging of the product the worker is trying to locate, especially when the packaging of the product the worker is trying to locate is unfamiliar to the worker or if the machine readable codes on the products are not readily visible. Such issues often make the worker's task of picking the right product off the shelf very difficult, often resulting in errors by the workers when attempting to pick the right product out of several related products stocked on a given shelf.

### BRIEF DESCRIPTION OF THE DRAWINGS

Disclosed herein are embodiments of systems, apparatuses and methods pertaining to uniquely identifying a plurality of products within a family of related products. This description includes drawings, wherein:

FIG. 1 is a diagram of a system of uniquely identifying a plurality of products within a family of related products in accordance with some embodiments;

FIG. 2 is a simplified block diagram of an electronic inventory management device in accordance with some embodiments;

FIG. 3 is a simplified block diagram of an exemplary worker interface device in accordance with some embodiments; and

FIG. 4 is a flow chart illustrating a method of uniquely identifying a plurality of products within a family of related products in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common, well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, methods of labeling related consumer products with unique randomly-generated identifiers, and units of related consumer product provided with labels that include the unique randomly-generated identifiers are described.

In one embodiment, a plurality of products within a family of related products stored at a retail facility include an identifier including a first sequence of characters that identifies a type of each of the plurality of products within the family of the related products, and a second sequence of at least two characters that is different among each of the plurality of products within the family of the related products. The second sequence provides a visual characteristic that distinguishes the products within the family of related products from one another.

In another embodiment, a method of uniquely identifying a plurality of products within a family of related products stored at a retail facility includes generating, via a computing device including a processor-based control circuit, an identifier for each of the products within the family of related products, the identifier of each of the products within the family of products including a first sequence of characters that identifies a type of each of the plurality of products within the family of the related products, and a second sequence of at least two characters that is different among each of the plurality of products within the family of the related products; creating, via the computing device, a label including the generated identifier; and applying the created label including the generated identifier to each of the products within the family of related products; wherein the second sequence of the identifier, provides a visual characteristic that distinguishes the products within the family of related products from one another.

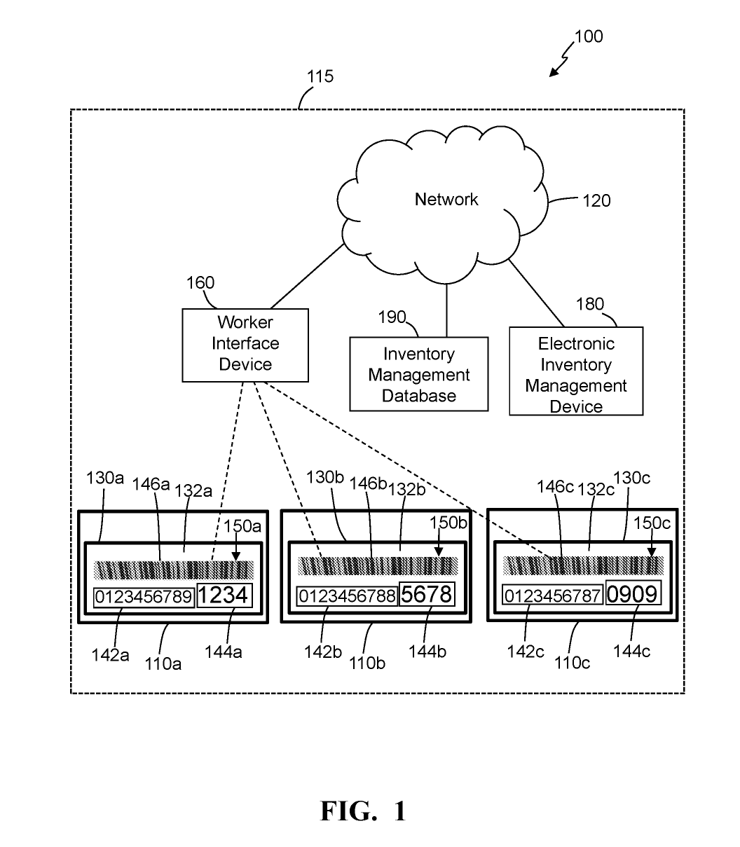

FIG. 1 shows an embodiment of a plurality of items 110a-c within a family of related products stored at a retail facility 115. Each of the items 110a-c has a label 130a-c coupled thereto in order to uniquely identify the items 110a-c. It will be understood that the term “item” herein refers not only to the physical items 110a-c themselves, but also to any packaging (e.g., case, box, or the like) associated with the items 110a-c. The term “related products” will be understood to mean a group of products manufactured by a single company (or by different companies) that are logically related (e.g., by being alternatives and/or supplements to one another), such that a consumer considering to buy one of the related products likely be interested in buying another one of the related products. For example, the items 110a-c may be juices made by the same company and having similar packaging, with item 110a being apple juice, item 110b being orange juice, and item 110c being pomegranate juice. In another example, items 110a-c may be corn chips made by the same company and having similar packaging, with item 110a being triangles, item 110b being rounds, and item 110c being strips. In yet another example, items 110a-c may be bath products made by the same company and having similar packaging, with item 110a being shampoo, item 110b being conditioner, and item 110c being body wash.

In the embodiment of FIG. 1, each item 110a-c includes a label 130a-c affixed to the item 110 as discussed above. An item 110a-c may be received at the retail facility 115 from a vendor (e.g., manufacturer, distributor, or the like) with or without including such labels 130. In other words, the labels 130a-c may be generated and affixed to the items 110a-c at a vendor facility, or may be generated and affixed to the items 110a-c at the retail facility 115. It will be understood that the physical location of the labels 130a-c on the item 110 in FIG. 1 is illustrated by way of example only, and that the labels 130a-c may be placed on any suitable location on a front, rear, or either side of the item 110.

As shown in FIG. 1, each label 130a-c includes a substrate 132a-c. The substrate 132a-c has one side (shown in FIG. 1) having printed indicia thereon and an opposite side (not visible in FIG. 1) having an adhesive material thereon that permits the labels 130a-c to be attached to the items 110a-c. In some embodiments, the substrates 132a-c of the labels 130a-c may be configured to include an adhesive that permits the labels 130a-c to be removed from the items 110a-c without ripping and/or otherwise damaging the labels 130a-c or the items 110a-c or the packaging of the items 110a-c. As such, in some embodiments, the labels 130a-c may be removed from the items 110a-c by a worker at the retail facility 115 prior to shipment of the items 110a-110c to the consumers. In some embodiments, the substrates 132a-c of the labels 130a-c may be configured to include an adhesive that does not permit the labels 130a-c to be removed from the items 110a-c without ripping and/or otherwise damaging the labels 130a-c or the items 110a-c or the packaging of the items 110a-c. As such, in some embodiments, the labels 130a-c may remain on the items 110a-c that are shipped to the consumers. As used herein, a retail facility 115 as shown in FIG. 1 may be any place of business such as a store, warehouse, sorting facility, and/or distribution facility where consumer products may be stocked, and/or sold, and/or shipped to, and/or shipped from.

In the embodiment shown in FIG. 1, each label 130a-c includes an identifier 150a-c that uniquely identifies each of the items 110a-c. In the embodiment of FIG. 1, the identifiers 150a-c are represented by a barcode 146a-c. It will be appreciated that the identifiers 150a-c are randomly-generated and may be represented by way of any other suitable indicia that may be readable by electronic label readers (e.g., barcode readers, QR code readers, radio frequency identification (RFID) readers, near field communication (NFC) readers, ultra-wideband (UWB) readers, image/video readers, mobile phones and/or tablets, polarized glasses, or the like readers).

Since each item 110a-c is identifiable by a unique randomly generated identifier 150a-c, each item 110a-c may be systematically indicated in an inventory management database 190 as being assigned to a specific storage location (e.g., stock room or sales floor of the retail facility 115), consolidation location, shipping package, customer order, transport unit, or the like. In some embodiments, the unique randomly-generated identifiers 150a-c on the labels 130a-c of the items 110a-c provide tracking information for the items 110a-c, whether the item 110 are being processed in receiving (e.g., from a manufacturer), storage (e.g., in a stock room), replenishment (e.g., delivery to the retail facility 115), order-filling (e.g., item sorting), consolidation (e.g., grouping multiple items 110a-c going to one customer), and shipping (e.g., delivery from retail facility 115 via delivery trucks or other delivery services). In some embodiments, the unique randomly-generated identifiers 150a-c on the labels 130a-c of the items 110a-c enable a consumer who ordered one or more of the items 110a-c for delivery to track the items 110a-c during order processing and delivery of the items 110a-c to the consumer.

In the embodiment shown in FIG. 1, each identifier 150a-c includes a first sequence of alphanumeric characters 142a-c and a second sequence of alphanumeric characters 144a-c oriented such that each first sequence 142a-c starts with the first character of the respective identifier 150-c, and the second sequence 144a-c ends with the last character of the respective identifier 150-c. The first and second sequences of alphanumeric characters 142a-c and 144a-c together represent the same unique identifier 150a-c as represented by the barcode 146a-c, respectively, but in alphanumeric form. In other words, there is a one-to-one correspondence between the first and second sequences of alphanumeric characters 142a-c and 144a-c and the barcode 146a-c (i.e., strip of black bars and white spaces). As will be discussed in more detail below, the presence of the first and second sequences of alphanumeric characters 142a-c and 144a-c on the labels 130a-c permits workers at the retail facility 115 to read the first and second sequences of alphanumeric characters 142a-c and 144a-c visually using non-enhanced human vision instead of having to use a barcode scanning device to read the barcode 146a-c representation of the identifiers 150a-c.

In some embodiments, the first sequence of alphanumeric characters 142 of each of the related items 110a-c represents a uniform product code associated with the products represented by the related items 110a-c. With reference to FIG. 1, the items 110a-c have different but similar first sequences of alphanumeric characters 142a-c, since the items 110a-c are all different, albeit related products. For example, in some aspects, if the items 110a-c are shampoo, conditioner, and body wash, respectively, each of which have a well-established and similar uniform product code associated therewith, the first sequence of alphanumeric numbers 142a-c on labels 130a-c generally identifies the items 110a-c as shampoo, conditioner, and body wash.

By way of example only, the first sequences of alphanumeric characters 142a-c of items 110a-c in FIG. 1 differ only in the last one of the 10 digits of the sequence, with the first sequence 142a of item 110a ending in a 9, the first sequence 142b of item 110b ending in an 8, and the first sequence 142c of item 110c ending in a 7.

Since the first sequences 142a-c of the identifiers 150a-c of items 110a-c are so similar, and since items 110a-c are typically stocked together on a shelf (or in a bin), there is a high likelihood that a worker at the retail facility 115 intending to pick item 110b (e.g., a case of conditioner having a uniform product code represented by the first sequence 142b of 0123456788) for shipping to a consumer may incorrectly pick item 110a (e.g., a case of shampoo having a uniform product code represented by the first sequence 142a of 0123456789) as a result of failing to see that the last digit of first sequence 142a is a 9, not an 8. As a result of such an inadvertent error by the worker, the shipment made to the consumer from the retail facility 115 will incorrectly contain item 110a instead of item 110b, likely leading to a return by the consumer and re-shipping by the retailer, which increases the retailer's costs and consumer's unhappiness.

To facilitate easier distinction of items 110a-c by workers at the retail facility 115, each identifier 150a-c of each item 110a-c a second sequence of alphanumeric characters 144a-c that uniquely identifies each of the items 110a-c and clearly provides a visual characteristic that distinguishes the items 110a-c from each other to a worker looking at the items 110a-c. As can be seen in FIG. 1, the second sequence 144a-c of each of the items 110a-c is different from the first sequence 142a-c. While the first sequence 142a-c of each of the items 110a-c is shown in FIG. 1 as having 10 characters, it will be appreciated that the first sequence 142a-c of each of the items 110a-c may have any number of characters (e.g., 14, 12, 8, etc.) suitable to uniquely identify the items 110a-c. Similarly, while the second sequence 144a-c of each of the items 110a-c is shown in FIG. 1 as having 4 characters, it will be appreciated that the second sequence 144a-c of each of the items 110a-c may have any number of characters (e.g., 2, 3, 5, 6, etc.) suitable to uniquely identify the items 110a-c and distinguish them one from another.

In some embodiments, the second sequence of alphanumeric characters 144a-c is a randomly-generated character sequence. In some aspects, each character of the second sequence 144a-c of each of the items 110a-c within the family of related products is different from the sequentially corresponding character of the second sequence 144a-c of each of the other items 110a-c. More specifically, as can be seen in FIG. 1, the sequence of characters of second sequence 144a is 1234, the sequence of characters of second sequence 144b is 5678, the sequence of characters of second sequence 144c is 0909. As such, the first character of second sequence 144a is 1, the first character of second sequence 144b is 5, and the first character of second sequence 144c is 0; the second character of second sequence 144a is 2, the second character of second sequence 144b is 6, and the second character of second sequence 144c is 9; the third character of second sequence 144a is 3, the third character of second sequence 144b is 7, and the third character of second sequence 144c is 0; and the fourth character of second sequence 144a is 4, the fourth character of second sequence 144b is 8, and the fourth character of second sequence 144c is 9.

While the exemplary second sequences 144a-c are shown in FIG. 1 as each having differing sequential characters, in some embodiments, each second sequence 144a-c may be represented by identical numeric characters. For example, in one aspect, the sequence of characters of second sequence 144a can be 1111, the sequence of characters of second sequence 144b can be 2222, and the sequence of characters of second sequence 144c can be 3333. As a result, in some embodiments, while each character of the second sequence 144a-c of each of the items 110a-c is different from the sequentially corresponding character of the second sequence 144a-c of each of the other items 110a-c, but each second sequence 144a-c individually comprises four identical characters.

It will be appreciated that in some embodiments, instead of each character of the second sequence 144a-c of each of the items 110a-c within the family of related products being different from the sequentially corresponding character of the second sequence 144a-c of each of the other items 110a-c, in some embodiments, only one, only two, or only three characters of second sequence 144a-c of each of the items 110a-c are different from the sequentially corresponding character of the second sequence 144a-c of each of the other items 110a-c. In other words, in some embodiments, the second sequences 144a-c of each of the items 110a-c are different from each other simply in that each second sequence 144a-c is represented by a unique overall four-digit number. For instance, second sequence 144a may be represented by numerical characters 1231, second sequence 144b may be represented by numerical characters 1232, and second sequence 144c may be represented by numerical characters 1233, such that a worker visually inspecting the second sequences 144a-c can clearly see that one of the sequences (144a) ends in 1, another of the sequences (144b) ends in 2, and another of the sequences (144c) ends in 3, which allows the worker to easily distinguish between the sequences 144a-c and items 110a-c.

It will also be appreciated that instead of numerical characters as shown in FIG. 1, the second sequences 144a-c of identifiers 150a-c may comprise letter characters (e.g., AAAA, BBBB, and CCCC; or ABCD, EFGG, and IJKL; or αααα, ββββ, γγγγ; or the like), graphical (colored or black-and-white) symbols (e.g., @@@@, ####, and ****; or ▴▴▴▴, [symbol] , and ▾▾▾▾; or the like), one or more lines or other geometric or irregular shapes, or any other indicia that may visually distinguish the identifiers 150a-c to a worker visually inspecting the labels 130a-c having identifiers 150a-c thereon.

Given that the second sequences 144a-c of items 110a-c are visually dissimilar to one another, the identifiers 150a-c advantageously enable a worker at the retail facility 115 inspecting the labels 130a-c using human vision non-enhanced by an electronic or another vision-enhancing device to clearly and easily distinguish between the items 110a-c and pick the right item 110a-c off the shelf (or out of a bin). In other words, despite the fact that items 110a-c are related products and may have similar visual characteristics and packaging, the randomly generated identifiers 150a-c, and more specifically, the second sequences 144a-c of the identifiers 150a-c on the labels 130a-c of the items 110a-c uniquely identify each item 110a-c separately and visually differentiate otherwise very similar-looking items 110a-c to advantageously reduce instances of human error arising from a worker inadvertently mistaking one items 110a-c for another, and incorrectly picking the wrong one of the items 110a-c for shipping to consumers or for stocking on a sales floor of the retail facility 115.

Generally, the randomly generated identifiers 150a-c on the labels 130 of items 110a-c enable a worker at the retail facility 115 to identify the specific item 110a-c the worker are intending to handle (e.g., to pick for loading into a delivery truck for delivery to a customer) by using the unique identifiers 150a-c to verify that the correct item 110a-c is being handled (e.g., picked). Such verification may be performed by the worker visually using non-enhanced human vision. As such, the presence of the unique, randomly-generated and highly visible identifiers 150a-c on the items 110a-c enables the worker to easily pick the correct item 110a-c off a shelf (e.g., in a stock room or warehouse) without having to carry a hand-held scanning device and having to scan the identifiers 150a-c of the items 110a-c using the hand-held scanning device in order to identify the items 110a-c. Thus, the items 110a-c can be scanned only once at the product loading location, where product scanners may be installed.

In some embodiments, the labels 130a-c are optically coded such that the identifiers 150a-c are visible to workers only when using a worker interface device 160. Generally, the worker interface device 160 can be any non-electronic or electronic device configured to facilitate a worker in obtaining the unique randomly-generated identifiers 150a-c from labels 130a-c of items 110a-c. In some embodiments, the worker interface device 160 is polarized glasses. In other aspects, the worker interface device 160 is an electronic device (e.g., a head-mounted or a hand-held device including an optical display) that (e.g., visually, physically, digitally, etc.) interacts with the identifiers 150a-c on the labels 130a-c in order to enable the worker to see the unique random-generated identifiers 150a-c and, more specifically, to see the unique and distinctive second sequences 144a-c that enable the worker to correctly pick out the correct item 110a-c.

In some embodiments, the labels 130a-c are optically coded such that the identifiers 150a-c are visible even in low light conditions to workers using non-enhanced human vision and/or to workers using the worker interface device 160 based on the visibly noticeable differences between the second sequences 144a-c of identifiers 150a-c of items 110a-c. In some aspects, the labels 130a-c are optically coded such that the identifiers 150a-c appear in different colors to a worker using non-enhanced human vision and/or to a worker using the worker interface device 160 to enable the worker to easily distinguish between items 110a-110c based on the different color of each item 110a-c.

With reference to FIG. 1, an exemplary system 100 of uniquely identifying a plurality of items 110a-c having labels 130a-c having unique identifiers 150a-c includes an electronic inventory management device 180 that facilitates the management of items 110a-c at retail facility 115. The electronic inventory management device 180 of FIG. 1 may be a stationary or portable electronic device, for example, a desktop computer, a laptop computer, a tablet, a mobile phone, or any other electronic device including a processor-based control circuit (i.e., control unit). The electronic inventory management device 180 may include and/or couple to one or more wired and/or wireless distributed communication network 120 (e.g., wide area network (WAN), local area network (LAN), wireless local area network (WLAN), Internet, cellular, other such networks, and combinations of such networks). The electronic inventory management device 180 is configured for data entry and one-way and/or two-way communication via the communication network 120 with, for example, an inventory management database 190, the worker interface device 160, and/or any other electronic device (e.g., regional and/or central server) located at the retail facility 115 or at a location remote to the retail facility 115.

In the embodiment shown in FIG. 1, the system 100 includes an inventory management database 190 configured to store electronic information associated with the items 110a-c at the retail facility 115, as well as the labels 130a-c associated with the items 110a-c. The inventory management database 190 may store electronic data including: randomly-generated identifiers 150a-c associated with the items 110, retailer-specific product identification codes associated with items 110a-c, manufacturer-specific codes associated with items 110a-c, uniform product codes associated with items 110a-c, location and/or status of items 110a-c (e.g., sold, shipped, stored in stock room, displayed on sales floor, on a delivery truck, etc.), condition of the items 110 (e.g., new, used, refurbished, etc.), and the like. In some aspects the unique randomly-generated identifiers 150a-c of items 110a-c may be associated in the inventory management database 190 to one or more of a manufacturer identification code (e.g., Frito-Lay), a product identification code (e.g., corn chips), and additional data (e.g., location, condition, status, expiration date, etc.) associated with the items 110a-c. In some embodiments, the first sequences 142a-c of the unique randomly-generated identifiers 150a-c do not correspond to the uniform product codes for items 110a-c and do not identify the items 110a-c or the consumer product represented by the items 110a-c independent of the association of the unique randomly-generated identifier 150a-c with the items 110a-c in the inventory management database 190.

While the inventory management database 190 is shown in FIG. 1 as being separate from the electronic inventory management device 180 and in communication with the electronic inventory management device 180 via the communication network 120, it will be appreciated that the inventory management database 190 may be physically incorporated into and/or be electrically coupled (e.g., via a cable) to the electronic inventory management device 180. In addition, while one inventory management database 190 is shown in FIG. 1, the inventory management database 190 may include two or more separate databases that are in communication with each other.

The inventory management database 190 may be stored, for example, on non-volatile storage media (e.g., a hard drive, flash drive, or removable optical disk) internal to or external to relative to the electronic inventory management device 180. The inventory management database 190 may be stored on one or more servers or may be cloud-based. In some embodiments, the electronic data stored in the inventory management database 190 may be received from the electronic inventory management device 180. In some embodiments, the electronic data stored in the inventory management database 190 may be transmitted to the inventory management database 190 from another device such as the worker interface device 160.

In some embodiments, the electronic inventory management device 180 is in communication via the network 120 with one or more electronic worker interface devices 160. For example, the worker interface device 160 may allow a worker at a retail facility 115 to communicate with the electronic inventory management device 180 to receive and/or transmit information associated with labels 130a-c on items 110a-c and/or worker tasks associated with items 110a-c and/or status of items 110a-c at the retail facility 115, and to communicate with the inventory management database 190.

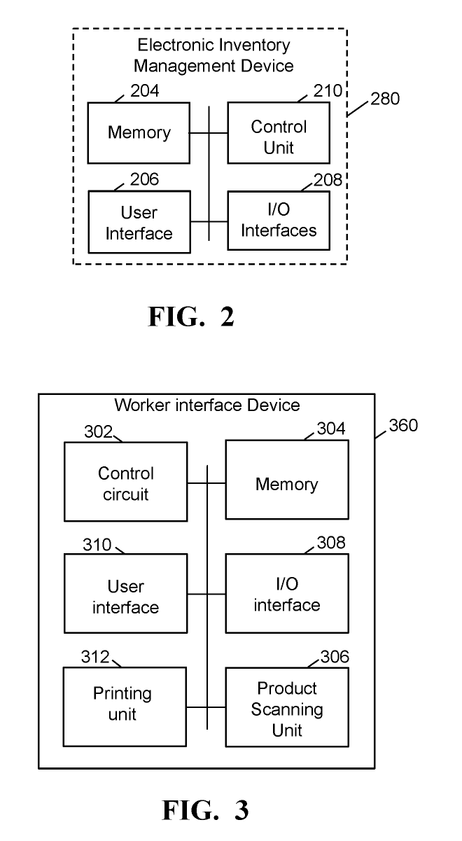

FIG. 2 shows a simplified block diagram of an exemplary electronic inventory management device 280, in accordance with some embodiments. The electronic inventory management device 280 includes one or more processor-based control circuits or control unit 210, memory 204, and input/output (I/O) interfaces 208. The electronic inventory management device 280 also includes one or more user interfaces 206 that allows users to interact with the inventory management database 190 and/or worker interface device 160.

In some embodiments, the control unit 210 includes one or more processors and/or microprocessors. The control unit 210 couples with and/or includes the memory 204. Generally, the memory 204 stores the operational code or set of instructions that is executed by the control unit 210 and/or processor to implement the functionality of the electronic inventory management device 280. It is understood that the control unit 210 may be implemented as one or more processor devices as are well known in the art. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. In some embodiments, the control unit 210 comprises a fixed-purpose hard-wired platform or can comprise a partially or wholly programmable platform. These architectural options are well known and understood in the art and require no further description here. The control unit 210 can be configured (for example, by using corresponding programming as will be well understood by those skilled in the art) to carry out one or more of the steps, actions, and/or functions described herein.

While the memory 204 is shown as internal to the electronic inventory management device 280, the memory 204 can be internal, external or a combination of internal and external memory. Also, the electronic inventory management device 280 may include a power supply (not shown) or it may receive power from an external source. In some instances, the control unit 210 and the memory 204 may be integrated together, such as in a microcontroller, application specification integrated circuit, field programmable gate array or other such device, or may be separate devices coupled together.

The one or more I/O interfaces 208 allow wired and/or wireless communication coupling of the electronic inventory management device 280 to external components, such as the inventory management database 190 and/or worker interface device 160, and other such components. Accordingly, the I/O interfaces 208 may include any known wired and/or wireless interfacing device, circuit and/or connecting device. For example, in some implementations, the I/O interface 208 includes one or more transceivers, receivers, and/or transmitters that provide wireless communication in accordance with one or more wireless protocols (e.g., Wi-Fi, Bluetooth, radio frequency (RF), cellular, other such wireless communication, or combinations of such communication).

The user interface 206 of the electronic inventory management device 280 can include substantially any known input device, such one or more buttons, knobs, selectors, switches, keys, touch input surfaces and/or displays, etc. Additionally, the user interface 206 may include one or more output display devices, such as lights, visual indicators, display screens, etc. to convey to a user any information relating to picking an item 110a-c from a shelf or bin at the retail facility 115. While FIG. 2 illustrates the exemplary components of the electronic inventory management device 280 being coupled together via a bus, it is understood that the components may actually be coupled to the control unit 210 and/or one or more other components directly.

In some embodiments, the control unit 210 of the electronic inventory management device 280 is configured to randomly generate, for each item 110a-c, a set of electronic data corresponding to the unique identifier 150a-c for a label 130a-c associated with an item 110a-c. In some embodiments, the unique random identifier 150a-c as described in more detail above may be generated in the form of a barcode, alphanumeric characters, non-alphanumeric graphical patterns, one or more lines, other geometric shapes, irregular shapes, or the like.

In some embodiments, the control unit 210 of the electronic inventory management device 280 may be programmed in some embodiments to query the inventory management database 190 to obtain information (e.g., worker tasks, order status, condition, etc.) pertaining to items 110a-c. In some aspects, such information may be associated in the inventory management database 190 with the randomly generated identifiers 150a-c transmitted to the electronic inventory management device 280 from a worker interface device 160 in response to a scanning of the label 130a-c on the item 110a-c. The information obtained by the electronic inventory management device 280 from the inventory management database 190, in some embodiments, is transmitted back to the worker interface device 160 to provide a worker with information and/or instructions pertaining to the scanned item 110a-c.

FIG. 3 shows a simplified block diagram of an exemplary worker interface device 360, in accordance with some embodiments. The worker interface device 360 includes one or more control circuits 302, memory 304, input/output (I/O) interfaces 308, and user interfaces 310. In some embodiments, the worker interface device 360 may include a product scanning unit 306 (e.g., barcode reader, radio frequency identification (RFID) reader, optical reader, or the like) and a printing unit 312. In some embodiments, the control circuit 302 includes one or more processors and/or microprocessors. The memory 304 stores the operational code or set of instructions that is executed by the control circuit 302 and/or processor to implement the functionality of the worker interface device 360. In some embodiments, the memory 304 may also store some or all of particular data that may be needed to make any of the associations, determinations, and/or communications described herein. Such data may be pre-stored in the memory, received from an external source (e.g., the electronic inventory management device 280), be determined, and/or communicated to the user interface unit.

The control circuit 302 and/or processor may be implemented as one or more processor devices as are well known in the art. Similarly, the memory 304 may be implemented as one or more memory devices as are known in the art, such as one or more processor readable and/or computer readable media and can include volatile and/or nonvolatile media, such as RAM, ROM, EEPROM, flash memory and/or other memory technology. Further, the memory 304 is shown as internal to the worker interface device 360, but the memory 304 can be internal, external or a combination of internal and external memory. Additionally, the worker interface device 360 may include a power supply (not shown) that may be rechargeable and/or it may receive power from an external source. While FIG. 3 illustrates the components of the worker interface device 360 being coupled together via a bus, it is understood that the components of the user interface device 36 may be coupled to the control circuit 302 and/or one or more other components directly.

Generally, the control circuit 302 and/or electronic components of the worker interface device 360 can include fixed-purpose hard-wired platforms or can comprise a partially or wholly programmable platform. These architectural options are well known and understood in the art and require no further description here. The user interface unit and/or control circuit can be configured (for example, by using corresponding programming as will be well understood by those skilled in the art) to carry out one or more of the steps, actions, and/or functions described herein. In some implementations, the control circuit 302 and the memory 304 may be integrated together, such as in a microcontroller, application specification integrated circuit, field programmable gate array or other such device, or may be separate devices coupled together.

The I/O interface 308 allows wired and/or wireless communication coupling of the worker interface device 360 to external components, such as the electronic inventory management device 180 and/or the inventory management database 190 shown in FIG. 1. Typically, the I/O interface 308 provides at least wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitter, receiver, transceiver, etc. The user interface 310 may be used for user input and/or output display. For example, the user interface 310 may include any known input devices, such one or more buttons, knobs, selectors, switches, keys, touch input surfaces, audio input, and/or displays, etc. Additionally, the user interface 310 may include one or more output display devices, such as lights, visual indicators, display screens, etc. to convey information relevant to the labels 130a-c and/or the items 110a-c to a user such as a worker at the retail facility 115. The user interface 310 in some embodiments may also include audio systems that can receive audio commands or requests verbally issued by a user, and/or output audio content.

In some embodiments, the worker interface device 360 includes a product scanning unit 306 configured to scan a label 130a-c of an item 110a-c to detect the unique randomly-generated identifier 150a-c and, in particular, the first and second alphanumeric character sequence 142a-c and 144a-c present on each label 130a-c. The randomly-generated identifier 150a-c on the label 130a-c that may be scanned by the product scanning unit 306 may include, but is not limited to: two dimensional barcode, alphanumeric characters, non-alphanumeric characters, RFID, NFC identifiers, ultra-wideband (UWB) identifiers, Bluetooth identifiers, images, or other optically readable, radio frequency detectable or other such code, or combination of such codes.

The worker interface device 360 according to some embodiments may include a printing unit 312. The printing unit 312 can be configured to allow the worker interface device 360 to print one or more labels 130a-c (including the randomly-generated unique identifiers 150a-c) that may be affixed to the items 110a-c at the retail facility 115. As such, a worker at a retail facility 115 may be instructed by an on-screen message (received, for example from the electronic inventory management device 180) on the worker interface device 360 instructing the worker to print, using the printing unit 312 of the worker interface device 360, a label 130a-c having a randomly generated identifier 150a-c that uniquely identifies the item 110a-c, and to apply the printed label 130a-c onto the item 110a-c. It will be appreciated that in some embodiments, the worker interface device 160 of FIG. 1 is a non-electronic device such an polarized glasses and that in such embodiments, the system 100 may include either a stationary printing unit directly coupled to the electronic inventory management device 180, or a hand-held printing unit configured for communication with the electronic inventory management device 180 via the network 120.

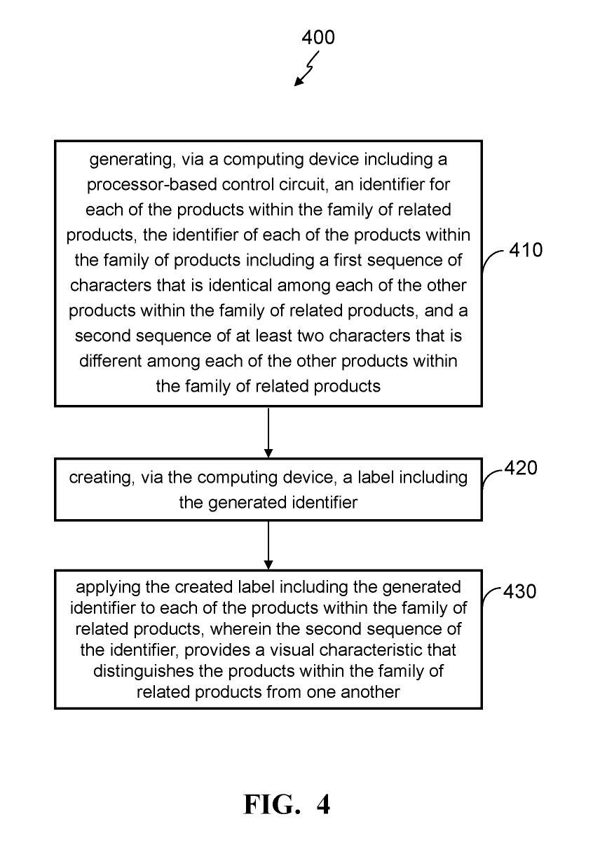

FIG. 4 illustrates a simplified flow diagram of an exemplary method 400 of uniquely identifying a plurality of items 110a-c within a family of related products stored at a retail facility 115. While the method 400 will be discussed as it applies to items 110a-c of FIG. 1, it will be appreciated that method 400 may be utilized in connection with any of the embodiments described herein.

With reference to FIG. 4, the method 400 includes generating, via an electronic inventory management device 180 including a processor-based control circuit 210, an identifier 150a-c for each of the items 110a-c within the family of related products (step 410). As illustrated in FIG. 4, in the exemplary method 400, the identifier 150a-c of each of the items 110a-c within the family of products includes a first sequence 142a-c of characters that is identifies a type of product of each of the items 110a-c, and a second sequence 144a-c of at least two characters that is different among each of the other products within the family of related products and that distinguishes the items 110a-c from one another.

As discussed above, in some embodiments, the identifiers 150a-c are randomly generated by the electronic inventory management device 180. For example, the control unit 210 of the electronic inventory management device 180 at the retail facility 115 may be programmed to randomly generate a unique identifier 150a-c for association with a label 130a-c that will be affixed to an item 110a-c. Alternatively, the unique identifier 150 may be generated by a computing device of a vendor (e.g., manufacturer) prior to delivery of the item 110a-c to the retail facility 115. As discussed above, each identifier 150a-c includes a first sequence of alphanumeric characters 142a-c and a second sequence of alphanumeric characters 144a-c that permit a worker at the retail facility 115 to read the first and second sequences 142a-c and 144a-c even when using non-enhanced human vision, and enable the worker to easily distinguish items 110a-c from one another based on the visually detectable differences between the alphanumeric (or other) characters of the second sequences 144a-c among the items 110a-c.

In some embodiments, the control unit 210 of the electronic inventory management device 180 is programmed to associate the unique identifier 150a-c randomly generated for an item 110a-c with another identifier for that item 110a-c (e.g., manufacturer-specific code and/or product-specific code for the item 110) stored in a record of the inventory management database 190, such that the randomly-generated identifier 150a-c is uniquely associated with the item 110a-c in the inventory management database 190. As described above, given that each item 110a-c processed at the retail facility 115 is uniquely identified by the randomly-generated identifier 150a-c, each item 110a-c located at the retail facility 115 and/or being transported from the retail facility 115 after being picked by the worker at the retail facility 115 may be accurately tracked by the worker.

The exemplary method 400 of FIG. 4 includes creating, via the computing device, a label 130a-c including the generated identifier 150a-c (step 420). As described above, in some embodiments, a label 130a-c is created via a printing unit 312 of the worker interface device 360 after receiving a signal including the randomly-generated identifier 150a-c to be printed on the label 130a-c from the electronic inventory management device 180. In some embodiments, the label 130a-c can be printed at the retail facility 115 via a stand-alone printing device at the retail facility 115 in communication with the electronic inventory management device 180.

As described above, in some embodiments, each created label 130a-c includes an adhesive substrate 132a-c that permits the label 130a-c to be securely attached to the their respective items 110a-c. In some embodiments, the method 400 further includes applying the label 130a-c to the item 110a-c, which may include a worker (e.g., at a vendor facility or at the retail facility 115) peeling a backer off the substrate 132a-c and affixing the label 130a-c via an adhesive found on a rear side of the substrate 132a-c to the item 110a-c. In some embodiments, the label 130a-c may be applied by an automated device such as a robotic arm or the like, for example in an automated sequence of printing the label 130a-c and applying the label 130a-c to the item 110a-c.

The systems and methods described herein provide for labeling of products with unique randomly-generated identifiers that permit workers at retailer facilities to accurately and easily visually distinguish the items in a family of related products from one another despite an overall similar appearance of such products. The labeling of products with such unique randomly-generated identifiers advantageously reduces picking errors by workers, advantageously reducing shipments of incorrect products that were incorrectly picked by the workers. Accordingly, the systems and methods described herein advantageously improve worker efficiency, reduce errors, and provide for significant cost savings to retail facilities.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A plurality of identifier-labeled products comprising:
a plurality of products within a family of related products stored at a retail facility;
an identifier, for each of the plurality of products within the family of related products, including a first sequence of characters that identifies a type of each of the plurality of products within the family of the related products, and a second sequence of at least two characters that is different among each of the plurality of products within the family of the related products;
wherein the second sequence provides a visual characteristic that distinguishes different products within the family of related products from one another.

2. The products of claim 1, wherein the first sequence of the identifier of each of the products within the family of related products represents a uniform product code associated with the products, and wherein the second sequence is distinct from the first sequence.

3. The products of claim 1, wherein the second sequence is a randomly-generated character sequence.

4. The products of claim 1, wherein the first sequence starts with a first character of the identifier, and wherein the second sequence ends with a last character of the identifier.

5. The products of claim 1, wherein each character of the second sequence of each of the products within the family of related products is different from a sequentially corresponding character of the second sequence of each of the other products within the family of related products.

6. The products of claim 1, wherein the second sequence includes at least one of: numeric characters, letter characters, and colored symbols.

7. The products of claim 1, wherein each of the products within the family of products further comprises a label attached thereto and including the identifier thereon.

8. The products of claim 7, wherein the identifier on the label is visible to a worker at the retail facility when the worker uses non-enhanced human vision.

9. The products of claim 7, wherein the label is optically coded such that the identifier on the label is visible to a worker at the retail facility when the worker uses an electronic device including an optical filter.

10. The products of claim 7, wherein the label is polarized such that the identifier on the label is visible to a worker at the retail facility when the worker uses polarized glasses.

11. A method of uniquely identifying a plurality of products within a family of related products stored at a retail facility, the method comprising:
generating, via a computing device including a processor-based control circuit, an identifier for each of the products within the family of related products, the identifier of each of the products within the family of products including a first sequence of characters that identifies a type of each of the plurality of products within the family of the related products, and a second sequence of at least two characters that is different among each of the plurality of products within the family of the related products;
creating, via the computing device, a label including the generated identifier; and
applying the created label including the generated identifier to each of the products within the family of related products;
wherein the second sequence of the identifier, provides a visual characteristic that distinguishes different products within the family of related products from one another.

12. The method of claim 11, wherein the first sequence of the identifier of each of the products within the family of related products represents a uniform product code associated with the products, and wherein the second sequence is distinct from the first sequence

13. The method of claim 11, wherein the generating step further comprises randomly generating, via the computing device, the characters of the second sequence

14. The method of claim 11, wherein the generating step further comprises generating, via the computing device, the identifier such that the first sequence starts with a first character of the identifier, and wherein the second sequence ends with a last character of the identifier.

15. The method of claim 11, wherein the generating step further comprises generating, via the computing device, the identifier such that each character of the second sequence of each of the products within the family of related products is different from a sequentially corresponding character of the second sequence of each of the other products within the family of related products.

16. The method of claim 11, wherein the generating step further comprises generating, via the computing device, the identifier such that the second sequence includes at least one of: numeric characters, letter characters, and colored symbols.

17. The method of claim 11, wherein the applying step further comprises attaching the created label to each of the products within the family of related products via an adhesive material.

18. The method of claim 11, wherein the creating step further comprises creating the label such that the identifier on the label is visible to a worker at the retail facility when the worker uses non-enhanced human vision.

19. The method of claim 11, wherein the creating step further comprises creating the label such that the identifier on the label is visible to a worker at the retail facility when the worker uses an electronic device including an optical filter.

20. The method of claim 11, wherein the creating step further comprises creating the label such that the identifier on the label is visible to a worker at the retail facility when the worker uses polarized glasses.
